(19) United States
(12) Patent Application Publication
(10) Pub. No.: US 2024/0134693 A1
(43) Pub. Date: Apr. 25, 2024

(54) QUANTUM-CLASSICAL CLUSTER CREATION VIA CLUSTER MANAGEMENT SERVICE

(71) Applicant: Red Hat, Inc., Raleigh, NC (US)

(72) Inventors: Leigh Griffin, Waterford (IE); Luigi Mario Zuccarelli, Dublin (IE); Stephen Coady, Waterford (IE)

(21) Appl. No.: 17/970,525

(22) Filed: Oct. 19, 2022

(51) Int. Cl. G06F 9/50

(52) U.S. Cl. CPC G06F 9/5027

(57) ABSTRACT

Embodiments of the present disclosure provide techniques for a quantum implementation of a cluster management service that uses quantum cluster management services to federate the cluster management service across multiple quantum machines. A request from a client to create a cluster in which a workload is to be deployed may be received at a classical cluster management service. The request may be decomposed to determine a set of workload parameters and resource availability information for each of a set of quantum machines may be determined using a set of quantum cluster management services, each of which may execute on a respective quantum machine. The workload parameters are compared to the resource availability information for each of the set of quantum machines to determine whether the workload can be executed on a single quantum machine of the set of quantum machines. The workload may be deployed on one or more of the set of quantum machines based on the comparison.

### TECHNICAL FIELD

Aspects of the present disclosure relate to an enhanced cluster management service that can discover quantum machines and the available resources therein, as well as create quantum clusters within quantum machines using the resources discovered therein.

### BACKGROUND

A container-orchestration system may automate many of the manual processes involved in deploying, managing, and scaling containerized applications. For example, a container-orchestration system for developing and running containerized applications may allow applications and the data centers that support them to expand from just a few machines and applications to thousands of machines that serve millions of clients. Services, such as a containerized application for example, are deployed within a node or group of nodes (hereinafter, “cluster”) of a container-orchestration system (e.g., Redhat™ OpenShift™ module on a Kubernetes® platform) and may depend on other services/libraries and their respective resources that are deployed within and outside the cluster in order to execute. For example, a web service may depend on a resource such as a database, in order to be able to persist its data. The services/libraries that a service depends on may be referred to herein as dependencies.

A cluster management service (e.g., Redhat™ Advanced Cluster Management service) may provide the ability to create a cluster that can be driven in an automated manner based on some API input. A cluster management service may decompose a client request, analyze the needs of the workload enumerated in the request, and instantiate a cluster to meet those needs. Clusters are often located in different geographical areas to provide high availability and highly robust systems. When a client wishes to deploy a workload using a cluster management service, the cluster management service may determine the available resources of clusters from each geographical area to determine the best cluster to deploy the workload on. When a client wishes to deploy a workload in a particular geographic area using the cluster management service, the cluster management service may determine which clusters in the particular geographical area have the highest availability/available resources to determine the best cluster to deploy the workload on. The cluster management service may balance resource consumption with the requirements of any applicable service level agreements (SLAs) of the workload when selecting clusters. If the available clusters are all unable to deploy the workload, then the cluster management service can spin a new cluster up (using any cloud provider's platform), use it to deploy the workload, and then tear the new cluster down.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates an example system, in accordance with some embodiments of the present disclosure.

FIG. 1B is a block diagram that illustrates an example system, in accordance with some embodiments of the present disclosure.

FIG. 1C is a block diagram that illustrates an example system, in accordance with some embodiments of the present disclosure.

FIG. 2A is a block diagram that illustrates executing a workload using a quantum cluster, in accordance with some embodiments of the present disclosure.

FIG. 2B is a block diagram that illustrates executing a workload using a quantum cluster, in accordance with some embodiments of the present disclosure.

FIG. 3 is a block diagram that illustrates creation of a quantum cluster across multiple quantum machines, in accordance with some embodiments of the present disclosure.

FIG. 4 is a flow diagram of a method of implementing an enhanced cluster management service that can discover quantum machines and the available resources therein, as well as create quantum clusters within quantum machines, in accordance with some embodiments of the present disclosure.

FIG. 5 is a block diagram of an example computing device that may perform one or more of the operations described herein, in accordance with some embodiments of the present disclosure.

### DETAILED DESCRIPTION

Quantum computing is a type of computation that harnesses the collective properties of quantum states, such as superposition, interference, and entanglement, to perform calculations. The devices that perform quantum computations are known as quantum computers. Although there are different types of quantum computers, one of the most widely used is the quantum circuit, based on the quantum bit (also referred to as a “qubit”). A qubit can be in a 1 or 0 quantum state, or in a superposition of the 1 and 0 states. When it is measured, however, it is always 0 or 1 and the probability of either outcome depends on the qubit's quantum state immediately prior to measurement. Using non-quantum hardware, a search problem with a search space of N items requires examination of the search space on the order of N times to find the item being sought. However, quantum hardware may solve the search problem after examining the search space approximately IN times. Although classical cluster management services can discover classical machines/computing devices and create clusters using classical hardware, they are unable to support creation of clusters that use quantum hardware.

The present disclosure addresses the above-noted and other deficiencies by Embodiments of the present disclosure provide techniques for a quantum implementation of a cluster management service that uses quantum cluster management services to federate the cluster management service across multiple quantum machines. A request from a client to create a cluster in which a workload is to be deployed may be received at a classical cluster management service. The request may be decomposed to determine a set of workload parameters and resource availability information for each of a set of quantum machines may be determined using a set of quantum cluster management services, each of which may execute on a respective quantum machine. The workload parameters are compared to the resource availability information for each of the set of quantum machines to determine whether the workload can be executed on a single quantum machine of the set of quantum machines. The workload may be deployed on one or more of the set of quantum machines based on the comparison.

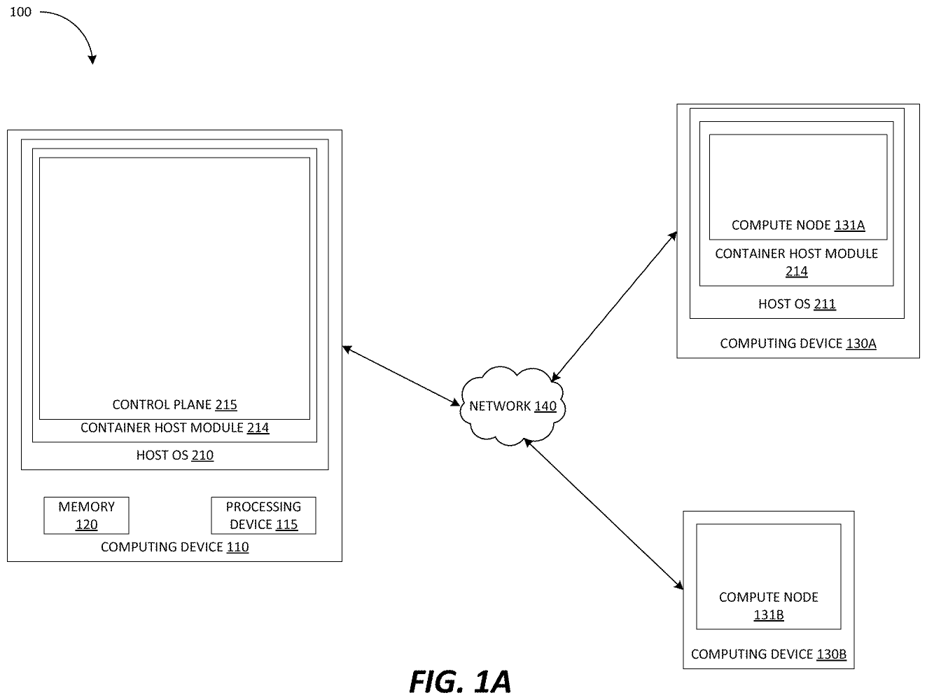

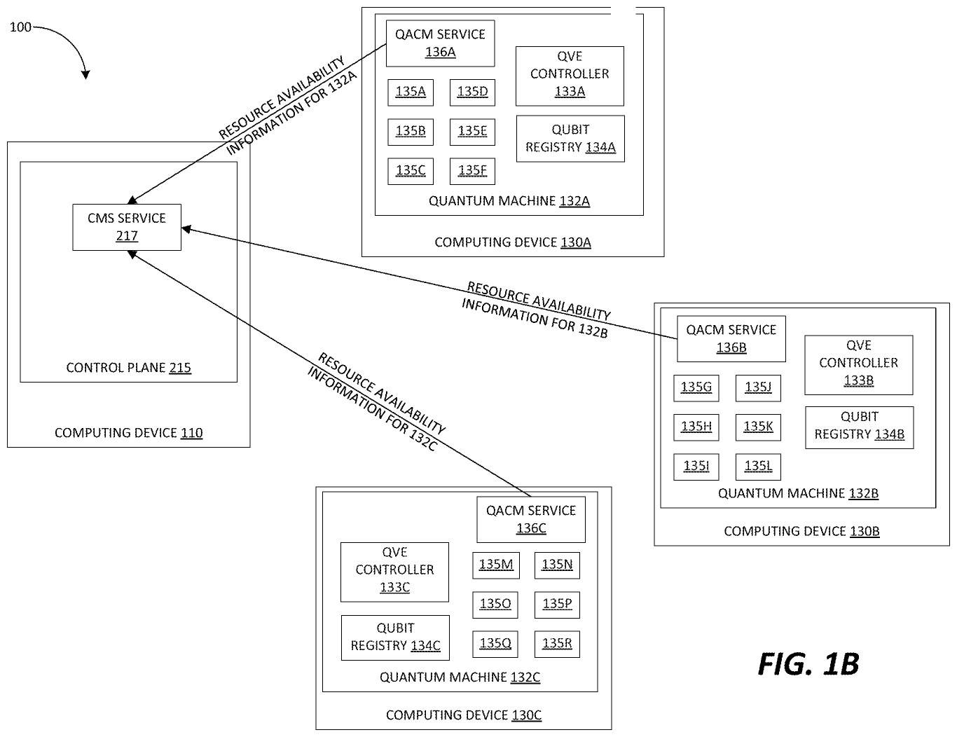

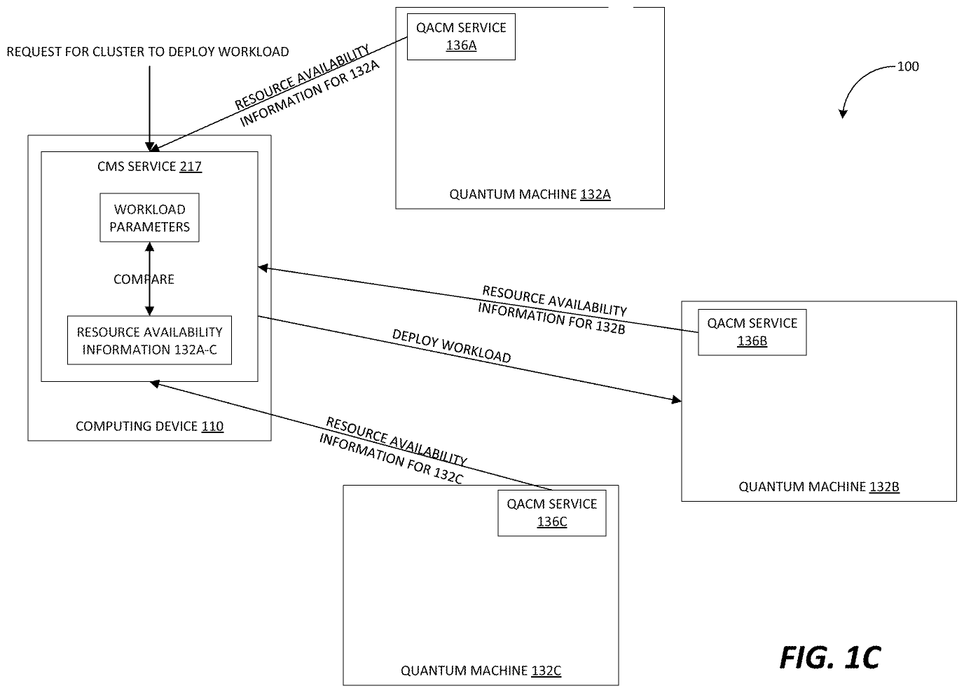

FIG. 1A is a block diagram that illustrates an example system 100. As illustrated in FIG. 1A, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi'm hotspot connected with the network 140 and/or a wireless carrier system that can be implemented using various data processing equipment, communication towers (e.g. cell towers), etc. In some embodiments, the network 140 may be an L3 network. The network 140 may carry communications (e.g., data, message, packets, frames, etc.) between computing device 110 and computing devices 130. Each computing device 110 and 130 may include hardware such as processing device 115 (e.g., processors, central processing units (CPUs), memory 120 (e.g., random access memory 120 (e.g., RAM), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110.

FIG. 1A and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

In some embodiments, each of the computing devices 110 and 130 may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 of computing device 110 and 130A respectively, as discussed in more detail below. The host OS of a computing device may manage the execution of other components (e.g., software, applications, etc.) and/or may manage access to the hardware (e.g., processors, memory, storage devices etc.) of the computing device.

In some embodiments, a container orchestration engine 214 (referred to herein as container host 214), such as the Redhat™ OpenShift™ module, may execute on the host OS of each of the computing device 110 and the computing devices 130, as discussed in further detail herein. The container host 214 may be a platform for developing and running containerized applications and may allow applications and the data centers that support them to expand from just a few machines and applications to thousands of machines that serve millions of clients. The container host 214 may provide an image-based deployment module for creating containers and may store one or more image files for creating container instances. The container host 214 may include a storage driver (not shown), such as OverlayFS, to manage the contents of an image file including the read only and writable layers of the image file.

A typical deployment of the container host 214 may include a control plane 215 and a cluster of compute nodes 131, including compute nodes 131A and 131B (also referred to as compute machines). The compute nodes 131 may run the aspects of the container host 214 that are needed to launch and manage containers, pods, and other objects. For example, a compute node may be a physical server that provides the processing capabilities required for running containers in the environment. A compute node may also be implemented as a virtual server, logical container, or GPU, for example.

Referring to FIG. 1B, in some embodiments each of the computing devices 130 may comprise a quantum machine 132 that operates in a quantum environment but can operate using classical computing principles or quantum computing principles. When using quantum computing principles, the quantum machine 132 performs computations that utilize quantum-mechanical phenomena, such as superposition and entanglement. The quantum machine 132 may operate under certain environmental conditions, such as at or near 0° Kelvin. When using classical computing principles, the quantum machine 132 utilizes binary digits that have a value of either 1 or 0.

Each quantum machine 132 may implement a set of qubits 135. Each quantum machine 132 may include a qubit registry 134 that maintains information about the qubits 135, including, by way of non-limiting example, a total qubits counter that identifies the total number of qubits 135 implemented by the quantum machine 132 and a total number of available qubits counter that maintains a count of the total number of qubits 135 that are currently available for allocation.

Embodiments of the present disclosure may generate quantum virtual environments (QVEs) (also referred to herein as quantum clusters) using the hardware resources of one or more quantum machines 132. A QVE may be a virtual environment in which quantum processes execute and have access to allocated qubits 135, but no access or only controlled access to qubits 135 allocated to other QVEs. A QVE as discussed herein may comprise any appropriate type of virtual environment such as e.g., a quantum isolation zone (QIZ).

The qubit registry 134 of each quantum machine 132 also maintains qubit metadata (not shown) which comprises a plurality of metadata records, each of which maintains information about a corresponding qubit 135. Each metadata record includes a qubit identifier that contains an identifier of the qubit 135 to which the respective metadata record corresponds, a system availability status that identifies whether the corresponding qubit 135 is available for allocation at the quantum machine level, a QVE identifier (QVE ID) that identifies the QVE, if any, to which the corresponding qubit 135 has been allocated, and a QVE availability status (QVE AS) that identifies whether the corresponding qubit 135, if allocated to a QVE, is available in the QVE or has been allocated to a quantum process executing in the QVE. Each metadata record also includes a process identifier of the quantum process, if any, to which the corresponding qubit 135 has been allocated, a parent identifier that identifies a parent quantum process, if any, of the quantum process to which the corresponding qubit 135 has been assigned, and a child identifier that identifies a child quantum process, if any, of the quantum process to which the corresponding qubit 135 has been assigned. Each metadata record may also include additional metadata not relevant to the examples disclosed herein, such as metadata indicating a real-time state of the corresponding qubit 135, such as whether the qubit 135 is in an entangled state, is in superposition, or the like. While solely for purposes of illustration each quantum machine 132 is described as having only six qubits 135, it is apparent that each quantum machine 132 may have hundreds or thousands of qubits 135 in some implementations.

At the point in time illustrated in FIG. 1B, the qubits 135 are unallocated, and thus, the system availability status for each metadata record has a value of “A” indicating that the corresponding qubit 135 is available. The values of the other fields in the metadata records 28 are “NULL”, which can comprise any value that indicates that the field is empty.

Each quantum machine 132 includes a QVE controller 133 that, as described in greater detail below, operates to establish one or more QVEs. The QVE controller 133 may be an operating system component, such as a kernel module or the like, of an operating system. A QVE controller 133 may run at a ring 0 level of a processing device of a corresponding quantum machine 132 and thus execute in a kernel mode and a kernel space rather than as a user process in a user space. Each quantum machine 132 includes a task manager (not shown) that is configured to initiate a quantum process from a quantum program file, such as a quantum assembly language (QASM) file, or the like.

Continuing to refer to FIG. 1B, as discussed herein the control plane 215 may execute a cluster management service 217 (hereinafter “CMS 217”) that provides the ability to create a cluster that can be driven in an automated manner based on some API input and provides end-to-end management and control capabilities to manage the cluster. Examples of such capabilities may include cluster creation, application lifecycle, and security and compliance for each compute node across data centers and hybrid cloud environments that may be geographically separated. The CMS 217 may receive a request from a client to create a cluster in which a workload requiring quantum hardware/quantum phenomena may be deployed. The request may comprise a QASM file that includes quantum programming instructions that enumerate the requirements for execution of the workload (also referred to herein as the workload parameters).

Quantum machines 132 and the available resources thereof may be discovered in a manner similar to the discovery of any classical machine (computing device) and the capabilities for discovering classical machines provided by the CMS 217 (e.g., heartbeat mechanism etc.) can also be used to discover quantum machines. Thus, the CMS 217 may send a request to each QVE controller 133 to generate a QVE (not shown) and deploy a quantum cluster management service (qCMS) service 136 within it. In this way, a qCMS 136 that can communicate with the CMS 217 may be implemented on each quantum machine 132, By deploying a qCMS 136 on each quantum machine 132, the CMS 217 may be federated across the quantum machines 132. Each qCMS 136 may implement a discovery mechanism that abstracts hardware-based resource availability information from its respective quantum machine 132 using standard hardware application program interfaces (APIs). The resource availability information of a quantum machine 132 may include metadata such as a number of qubits 135 available, coherence level, current temperature of the quantum machine 132, T1 times, T2 times, quantum communication pathways provided by the quantum machine 132, quantum phenomena provided by the quantum machine 132, and error correction values of the quantum machine, among other metadata. In this way, each qCMS service 136 may continuously provide real-time snapshots of the resource availability information (hardware capabilities) of its respective quantum machine 132 to the CMS 217. Thus, if additional workloads suddenly start running on a particular quantum machine(s) 132, the CMS 217 may account for the increased workload/reduced hardware capabilities of the particular quantum machine(s) 132 when determining which quantum machine(s) 132 a requested workload should be deployed on, as discussed in further detail herein.

The CMS 217 may decompose the QASM file corresponding to the client request to determine the workload parameters. The workload parameters may include the number of qubits 135 required for execution of the workload, quantum communication pathways needed by the workload (e.g., quantum channels between certain machines), quantum phenomena the workload needs access to (e.g., teleportation, super dense encoding) for execution, and any temperature restrictions of the workload, among other information. In some embodiments, the workload parameters may also indicate whether certain parameters are more heavily weighted. For example, while a certain temperature sensitive workload may indicate a minimum temperature requirement, it may also assign a higher weight to temperature generally so that among multiple quantum machines 132 that satisfy the minimum temperature requirement, the quantum machine 132 having the lowest operating temperature would be selected. The workload parameters may be a set of combinatorial inputs which the CMS 217 may compare to the resource availability information of each quantum machine 132. More specifically, the CMS 217 may compare the workload parameters to the resource availability information of each quantum machine 132 in order to determine whether any of the set of quantum machines 132 have hardware capabilities (indicated by their resource availability information) that match or exceed the requirements for executing the workload, as enumerated in the workload parameters.

In some scenarios, based on the comparison of the workload parameters to the resource availability information of each quantum machine 132, the CMS 217 may identify a set of quantum machines 132 whose hardware capabilities match or exceed the requirements enumerated in the workload parameters. The CMS 217 may then identify a quantum machine 132 that is best suited to execute the workload from among the set of quantum machines 132 whose hardware capabilities match or exceed the requirements enumerated in the workload parameters. The CMS 217 may account for each of the workload parameters as well as any applicable weights assigned to them when selecting a quantum machine 132 best suited to execute the workload. For example, the CMS 217 may determine that the available resources of each quantum machine 132 satisfy the workload parameters. However, the workload parameters of the request may assign a higher weight to operating temperature. Thus, both quantum machine 132A and 132B provide the necessary number of qubits 135, the necessary quantum communication pathways, the necessary quantum phenomena, and meet the minimum temperature restrictions of the workload, the CMS 217 may determine that quantum machine 132B is the appropriate quantum machine 132 because it has a lower operating temperature than quantum machine 132A.

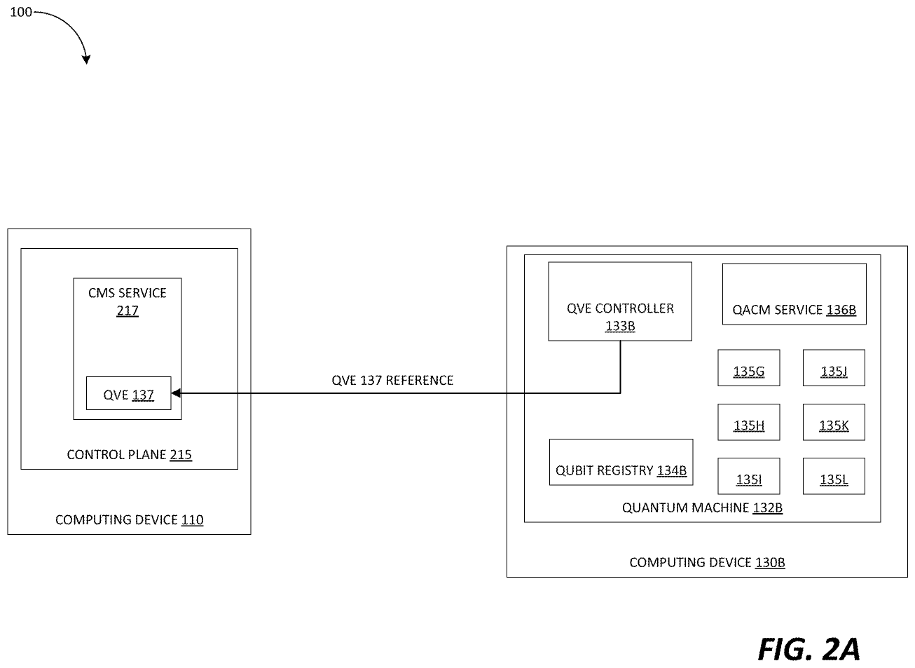

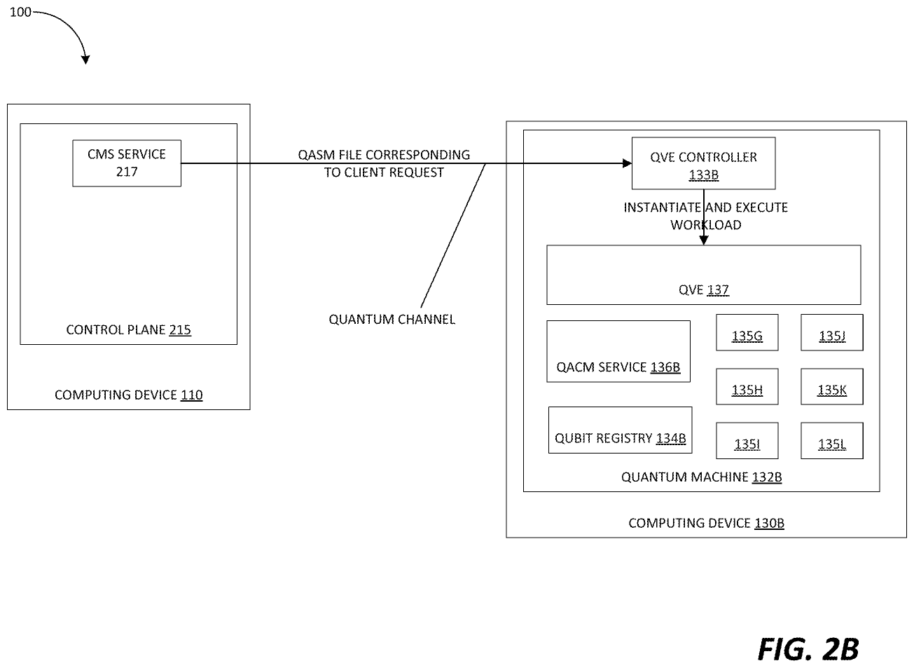

Upon determining the quantum machine 132 that is best suited to handle the request, the CMS 217 may request generation of a QVE 137 (shown in FIGS. 2A and 2B) on which the workload may be executed. The QVE 137 may comprise any appropriate quantum virtual environment in which the workload can be executed such as a quantum isolation zone (QIZ), but this is not a limitation and the QVE 137 may be any appropriate QVE. In the example of FIGS. 2A and 2B, the CMS 217 may determine that quantum machine 132B is best suited to handle the workload. The CMS 217 may communicate with the QVE controller 133B of the quantum machine 132B and request creation of the QVE 137 with resource capabilities that match the workload parameters. The CMS 217 may then deploy the workload using the QVE 137 in any of a number of ways. FIGS. 2A and 2B illustrate examples of deployment of the workload using the QVE 137.

As shown in FIG. 2A, in one example the CMS 217 may pass the QVE 137 as a reference to the client, as shown in FIG. 2A. There may be a number of situations where passing a reference to the CMS 217 to the client may be advantageous. For example, the requesting client may want to keep track of the QVEs it has requested for any of a number of reasons ranging from wanting to interact with a requested QVE in the future to orchestration changes. In another example illustrated in FIG. 2B, the CMS 217 may deploy the workload by passing the QASM file corresponding to the client request across a quantum channel to the QVE controller 133B for instantiation and execution of the workload on the QVE 137. Executing the workload on the quantum machine 132A may have a number of advantages including retaining administrative control over execution of the workload (i.e., retaining control of execution of the workload at the CMS 217 level) in situations where the client does not have the correct permissions.

Once execution of the workload is complete, the CMS 217 may initiate a tear down of the QVE 137. This is because leaving such QVEs running may unnecessarily consume qubits and other resources of the quantum machine 132B and increases the risk factor of decoherence in the QVE 137. As can be seen, the use of QVEs enables the ad-hoc creation of smaller quantum clusters that can be easily discarded once they have executed their assigned workload.

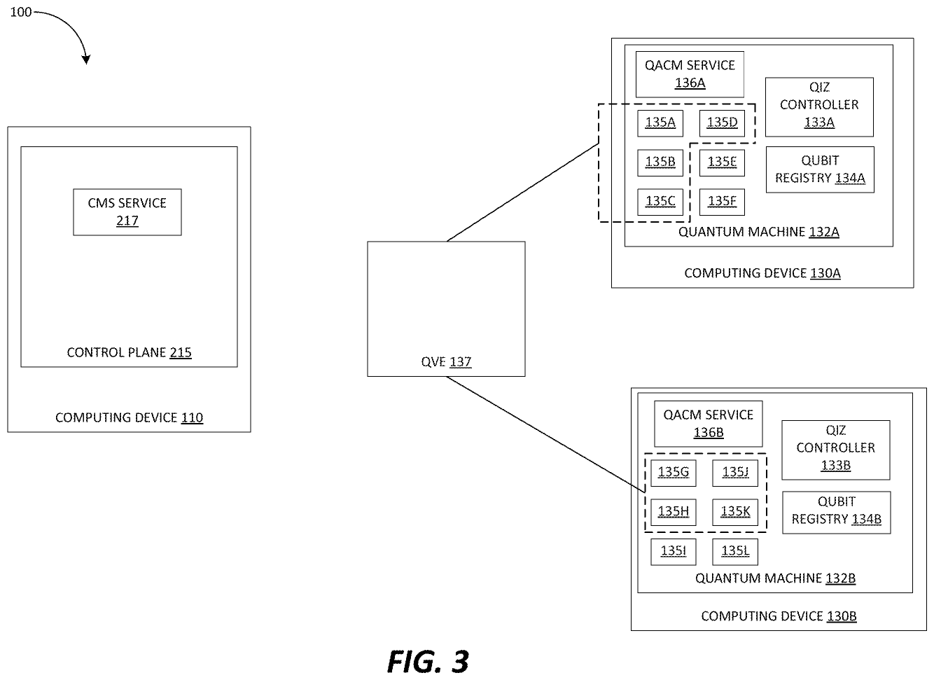

In some scenarios, when comparing the workload parameters to the resource availability information of each quantum machine 132, the CMS 217 may determine that the workload cannot be executed on a single quantum machine 132 (i.e., none of the quantum machines 132 have hardware capabilities that match or exceed the requirements for executing the workload). Thus, the CMS 217 may need to lock down qubits (and other resources) across multiple quantum machines 132 to thereby create the QVE 137 across the multiple quantum machines 132. Referring to FIG. 3, upon determining that the workload cannot be executed on a single quantum machine 132 (i.e., no single quantum machine 132 has sufficient available resources), the CMS 217 may identify a group of quantum machines 132 that is best suited to handle the workload. For example, the CMS 217 may determine that only quantum machine 132C can provide the quantum communication pathways needed by the workload and only quantum machine 132B can provide the quantum phenomena the workload needs access to. Thus, if quantum machines 132B and 132C together meet all of the other workload parameters, then CMS 217 may include quantum machines 132B and 132C in the group. As discussed above, the CMS 217 may account for all of the workload parameters as well as any weights assigned to them when selecting quantum machines 132 best suited to execute the workload.

In the example of FIG. 3, the workload parameters may specify that execution of the workload requires seven available qubits 135, access to quantum teleportation, and an execution environment that is below X Kelvin. The CMS 217 may examine the resource availability information of each quantum machine 132 and determine that quantum machine 132C has qubits 135M-135R available, but is currently operating at a temperature higher than X Kelvin. The CMS 217 may also determine that quantum machine 132A has qubits 135A-D available, while quantum machine 132B has qubits 135G-135I available. The CMS 217 may also determine that both quantum machines 132A and 132B are currently operating at below X Kelvin and that quantum machine 132B may provide quantum teleportation. Thus, the CMS 217 may add quantum machines 132A and 132B to a group across which the QVE 137 will be created.

The CMS 217 may accomplish this by entangling one or more qubit 135s from each of quantum machines 132A and 132B so that the QVE 137 may span both quantum machines 132A and 132B. The CMS 217 may communicate with the QVE controller 133A of the quantum machine 132A and the QVE controller 133B of the quantum machine 132B to request creation of the QVE 137 with relevant available resources of each quantum machine 132A and 132B that match the workload parameters. More specifically, each of the QVE controllers 133A and 133B may generate a respective QVE based on the available resources their corresponding quantum machines (132B and 132B respectively) will provide. In some embodiments, the CMS 217 may present these respective QVEs to the client together as a single QVE 137, and the requesting client may not be aware that the “symbolic” QVE 137 presented to them is in fact two separate QVEs. In other embodiments, the CMS 217 may combine these respective QVEs into a single QVE 137 and present the QVE 137 to the client. The CMS 217 may present the QVE 137 to the client in any appropriate manner including passing the QVE 137 as a reference to the client or passing the QASM file corresponding to the client request across a quantum channel to the QVE controllers 133A and 133B for instantiation and execution of the workload on the QVE 137 as discussed hereinabove. In this way, embodiments of the present disclosure allow ad-hoc creation of smaller purpose-built quantum clusters (QVEs) across quantum machines 132 that may be located in physically disparate geographic zones (e.g., machines hundreds of miles apart). As discussed above, the CMS 217 may deploy the workload using the QVE 137 either by passing the QVE 137 as a reference to the client or by passing the QASM file corresponding to the client request across a quantum channel to the QVE controllers 133A and 133B for instantiation and execution of the workload on the QVE 137.

As can be seen, deploying a qCMS in each quantum machine 132 provides the ability to federate the CMS 217 across the quantum machines 132, thereby allowing the CMS 217 to discover quantum machines and add a QVE to one or more quantum machines as well as programmatically combine and cross entangle multiple QVEs to form a system of QVEs.

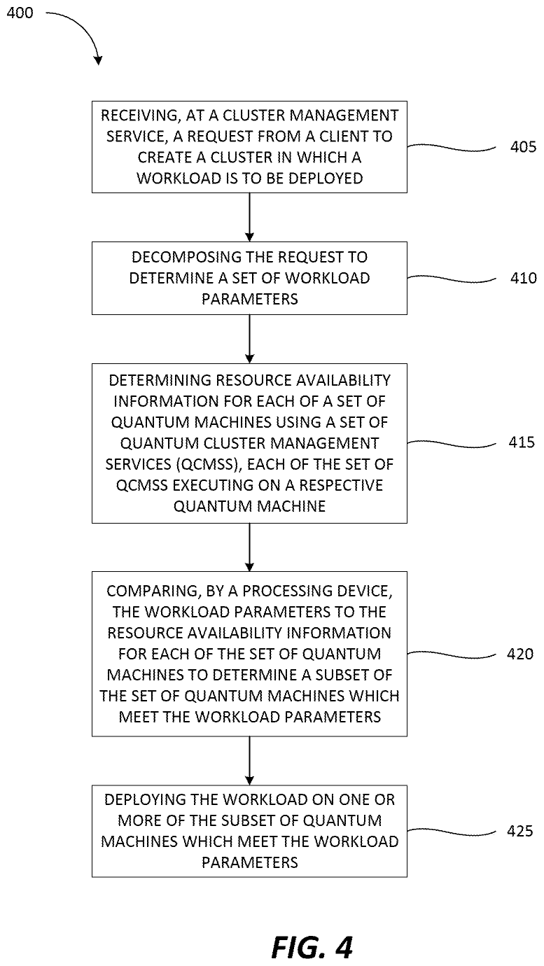

FIG. 4 is a flow diagram of a method 400 for implementing an enhanced cluster management service that can discover quantum machines and the available resources therein, as well as create quantum clusters within quantum machines, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed e.g., computing devices 110 and 130 illustrated in FIGS. 1A-2B.

Referring simultaneously to FIG. 1B, at block 405, the CMS 217 may receive a request from a client to create a cluster in which a workload may be deployed. The request may comprise a QASM file that includes quantum programming instructions that enumerate the client's requirements for the cluster (also referred to herein as the workload parameters).

At block 410, the CMS 217 may decompose the QASM file corresponding to the client request to determine the workload parameters. The workload parameters may include the number of qubits required for execution of the workload, quantum communication pathways needed by the workload (e.g., quantum channels between certain machines), quantum phenomena the workload needs access to (e.g., teleportation, super dense encoding) for execution, and any temperature restrictions of the workload, among other information. The workload parameters may comprise a set of combinatorial inputs which the CMS 217 may compare to the resource availability information of each quantum machine 132.

Quantum machines 132 and the available resources thereof may be discovered in a manner similar to the discovery of any classical machine (computing device) and the capabilities for discovering classical machines provided by the CMS 217 (e.g., heartbeat mechanism etc.) can also be used to discover quantum machines. Thus, the CMS 217 may send a request to each QVE controller 133 to generate a QVE (not shown) and deploy a quantum cluster management service (qCMS) service 136 within it. In this way, a qCMS 136 that can communicate with the CMS 217 may be implemented on each quantum machine 132. By deploying a qCMS 136 on each quantum machine 132, the CMS 217 may be federated across the quantum machines 132. Each qCMS service 136 may implement a discovery mechanism that abstracts hardware-based resource availability information from its respective quantum machine 132 using standard hardware APIs. The resource availability information of a quantum machine 132 may include metadata such as a number of qubits 135 available, coherence level, current temperature of the quantum machine 132, T1 times, T2 times, quantum communication pathways provided by the quantum machine 132, quantum phenomena provided by the quantum machine 132, and error correction values of the quantum machine, among other metadata. In this way, each qCMS service 136 may continuously provide real-time snapshots of the resource availability information (hardware capabilities) of its respective quantum machine 132 to the CMS 217. Thus, if additional workloads suddenly start running on a particular quantum machine(s) 132, the CMS 217 may account for the increased workload/reduced hardware capabilities of the particular quantum machine(s) 132 when determining which quantum machine(s) 132 a requested workload should be deployed on, as discussed in further detail herein.

At block 420, the CMS 217 may compare the workload parameters to the resource availability information of each quantum machine 132 in order to determine whether any of the set of quantum machines 132 have hardware capabilities (indicated by their resource availability information) that match or exceed the requirements for executing the workload, as enumerated in the workload parameters. At block 425, the CMS 217 may deploy the workload on one or more of the set of quantum machines 132 based on the comparison of the workload parameters to the resource availability information of each quantum machine 132. More specifically, in some scenarios, based on the comparison of the workload parameters to the resource availability information of each quantum machine 132, the CMS 217 may identify a set of quantum machines 132 whose hardware capabilities match or exceed the requirements enumerated in the workload parameters. The CMS 217 may then identify a quantum machine 132 that is best suited to execute the workload from among the set of quantum machines 132 whose hardware capabilities match or exceed the requirements enumerated in the workload parameters. The CMS 217 may account for each of the workload parameters as well as any applicable weights assigned to them when selecting a quantum machine 132 best suited to execute the workload. For example, the CMS 217 may determine that the available resources of each quantum machine 132 satisfy the workload parameters. However, the workload parameters of the request may assign a higher weight to operating temperature. Thus, both quantum machine 132A and 132B provide the necessary number of qubits 135, the necessary quantum communication pathways, the necessary quantum phenomena, and meet the minimum temperature restrictions of the workload, the CMS 217 may determine that quantum machine 132B is the appropriate quantum machine 132 because it has a lower operating temperature than quantum machine 132A.

Upon determining the quantum machine 132 that is best suited to handle the request, the CMS 217 may request generation of a QVE 137 (shown in FIGS. 2A and 2B) on which the workload may be executed. The QVE 137 may comprise any appropriate quantum virtual environment in which the workload can be executed such as a quantum isolation zone (QIZ), but this is not a limitation and the QVE 137 may be any appropriate QVE. In the example of FIGS. 2A and 2B, the CMS 217 may determine that quantum machine 132B is best suited to handle the workload. The CMS 217 may communicate with the QVE controller 133B of the quantum machine 132B and request creation of the QVE 137 with resource capabilities that match the workload parameters. The CMS 217 may then deploy the workload using the QVE 137 in any of a number of ways. FIGS. 2A and 2B illustrate examples of deployment of the workload using the QVE 137.

As shown in FIG. 2A, in one example the CMS 217 may pass the QVE 137 as a reference to the client, as shown in FIG. 2A. There may be a number of situations where passing a reference to the CMS 217 to the client may be advantageous. For example, the requesting client may want to keep track of the QVEs it has requested for any of a number of reasons ranging from wanting to interact with a requested QVE in the future to orchestration changes. In another example illustrated in FIG. 2B, the CMS 217 may deploy the workload by passing the QASM file corresponding to the client request across a quantum channel to the QVE controller 133B for instantiation and execution of the workload on the QVE 137. Executing the workload on the quantum machine 132A may have a number of advantages including retaining administrative control over execution of the workload (i.e., retaining control of execution of the workload at the CMS 217 level) in situations where the client does not have the correct permissions.

Once execution of the workload is complete, the CMS 217 may initiate a tear down of the QVE 137. This is because leaving such QVEs running may unnecessarily consume qubits and other resources of the quantum machine 132B and increases the risk factor of decoherence in the QVE 137. As can be seen, the use of QVEs enables the ad-hoc creation of smaller quantum clusters that can be easily discarded once they have executed their assigned workload.

In some scenarios, when comparing the workload parameters to the resource availability information of each quantum machine 132, the CMS 217 may determine that the workload cannot be executed on a single quantum machine 132 (i.e., none of the quantum machines 132 have hardware capabilities that match or exceed the requirements for executing the workload). Thus, the CMS 217 may need to lock down qubits (and other resources) across multiple quantum machines 132 to thereby create the QVE 137 across the multiple quantum machines 132. Referring to FIG. 3, upon determining that the workload cannot be executed on a single quantum machine 132 (i.e., no single quantum machine 132 has sufficient available resources), the CMS 217 may identify a group of quantum machines 132 that is best suited to handle the workload. For example, the CMS 217 may determine that only quantum machine 132C can provide the quantum communication pathways needed by the workload and only quantum machine 132B can provide the quantum phenomena the workload needs access to. Thus, if quantum machines 132B and 132C together meet all of the other workload parameters, then CMS 217 may include quantum machines 132B and 132C in the group. As discussed above, the CMS 217 may account for all of the workload parameters as well as any weights assigned to them when selecting quantum machines 132 best suited to execute the workload.

In the example of FIG. 3, the workload parameters may specify that execution of the workload requires seven available qubits 135, access to quantum teleportation, and an execution environment that is below X Kelvin. The CMS 217 may examine the resource availability information of each quantum machine 132 and determine that quantum machine 132C has qubits 135M-135R available, but is currently operating at a temperature higher than X Kelvin. The CMS 217 may also determine that quantum machine 132A has qubits 135A-D available, while quantum machine 132B has qubits 135G-135I available. The CMS 217 may also determine that both quantum machines 132A and 132B are currently operating at below X Kelvin and that quantum machine 132B may provide quantum teleportation. Thus, the CMS 217 may add quantum machines 132A and 132B to a group across which the QVE 137 will be created.

The CMS 217 may accomplish this by entangling one or more qubit 135s from each of quantum machines 132A and 132B so that the QVE 137 may span both quantum machines 132A and 132B. The CMS 217 may communicate with the QVE controller 133A of the quantum machine 132A and the QVE controller 133B of the quantum machine 132B to request creation of the QVE 137 with relevant available resources of each quantum machine 132A and 132B that match the workload parameters. More specifically, each of the QVE controllers 133A and 133B may generate a respective QVE based on the available resources their corresponding quantum machines (132B and 132B respectively) will provide. In some embodiments, the CMS 217 may present these respective QVEs to the client together as a single QVE 137, and the requesting client may not be aware that the “symbolic” QVE 137 presented to them is in fact two separate QVEs. In other embodiments, the CMS 217 may combine these respective QVEs into a single QVE 137 and present the QVE 137 to the client. The CMS 217 may present the QVE 137 to the client in any appropriate manner including passing the QVE 137 as a reference to the client or passing the QASM file corresponding to the client request across a quantum channel to the QVE controllers 133A and 133B for instantiation and execution of the workload on the QVE 137 as discussed hereinabove. In this way, embodiments of the present disclosure allow ad-hoc creation of smaller purpose-built quantum clusters (QVEs) across quantum machines 132 that may be located in physically disparate geographic zones (e.g., machines hundreds of miles apart). As discussed above, the CMS 217 may deploy the workload using the QVE 137 either by passing the QVE 137 as a reference to the client or by passing the QASM file corresponding to the client request across a quantum channel to the QVE controllers 133A and 133B for instantiation and execution of the workload on the QVE 137.

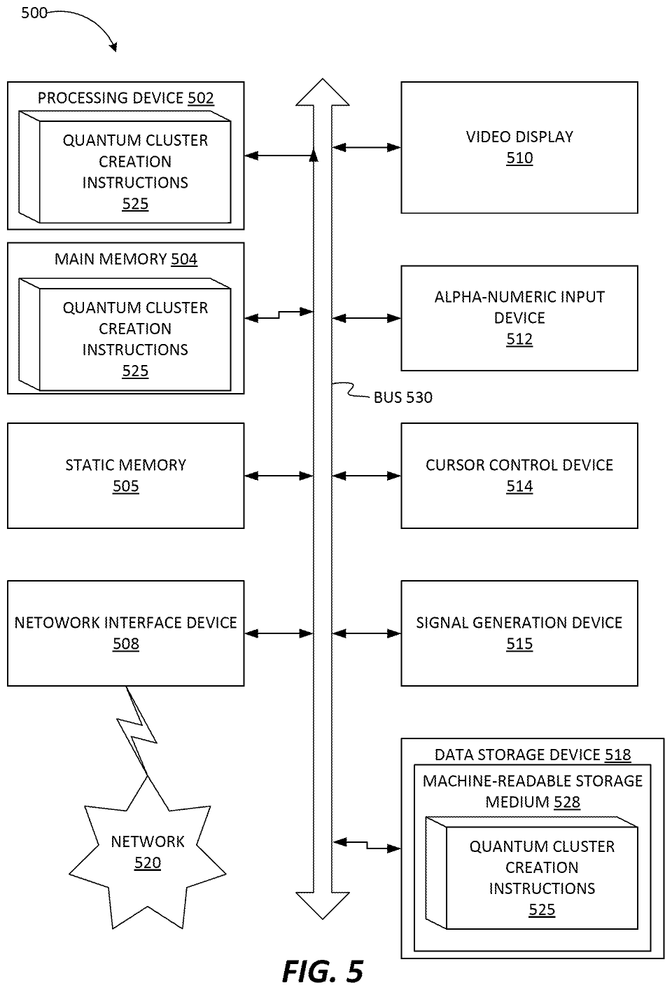

FIG. 5 illustrates a diagrammatic representation of a machine in the example form of a computer system 500 within which a set of instructions, for causing the machine to perform any one or more of the methodologies discussed herein for implementing an enhanced cluster management service that can discover quantum machines and the available resources therein, as well as create quantum clusters within quantum machines.

In alternative embodiments, the computer system 500 may be connected (e.g., networked) to other machines in a local area network (LAN), an intranet, an extranet, or the Internet. The computer system 500 may operate in the capacity of a server or a client machine in a client-server network environment, or as a peer machine in a peer-to-peer (or distributed) network environment. The computer system 500 may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single computer system is illustrated, the terms “computer system” and “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 430. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute quantum cluster creation instructions 525, for performing the operations and steps discussed herein.

The data storage device 518 may include a machine-readable storage medium 528, on which is stored one or more sets of quantum cluster creation instructions 525 (e.g., software) embodying any one or more of the methodologies of functions described herein. The quantum cluster creation instructions 525 may also reside, completely or at least partially, within the main memory 504 or within the processing device 502 during execution thereof by the computer system 500; the main memory 504 and the processing device 502 also constituting machine-readable storage media. The quantum cluster creation instructions 525 may further be transmitted or received over a network 520 via the network interface device 508.

The machine-readable storage medium 528 may also be used to store instructions to perform a method for object analysis/validation event publishing, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Example 1 is a method comprising: receiving, at a cluster management service, a request from a client to create a cluster in which a workload is to be deployed; decomposing the request to determine a set of workload parameters; determining resource availability information for each of a set of quantum machines using a set of quantum cluster management services (qCMSs), each of the set of quantum cluster management services executing on a respective quantum machine; comparing, by a processing device, the workload parameters to the resource availability information for each of the set of quantum machines to determine whether the workload can be executed on a single quantum machine of the set of quantum machines; and deploying the workload on one or more of the set of quantum machines based on the comparing.

Example 2 is the method of example 1, wherein deploying the workload on the one or more quantum machines comprises: determining that the workload can be executed on a single quantum machine of the set of quantum machines; sending a request to a quantum virtual environment (QVE) controller of the single quantum machine to generate a QVE based on the set of workload parameters; and deploying the workload using the QVE.

Example 3 is the method of example 2, wherein deploying the workload using the QVE comprises: transmitting a quantum assembly language (QASM) file corresponding to the request across a quantum channel to the QVE controller; and executing, by the QVE controller, the workload on the QVE using the QASM file corresponding to the request.

Example 4 is the method of example 2, wherein deploying the workload using the QVE comprises: transmitting the QVE as a reference to the client.

Example 5 is the method of example 1, wherein deploying the workload on the one or more quantum machines comprises: determining that the workload must be executed on two or more quantum machines of the set of quantum machines; entangling one or more qubits from each of the two or more quantum machines to generate a QVE; and deploying the workload using the QVE.

Example 6 is the method of example 1, wherein the workload parameters comprise: a number of qubits required for the workload, one or more communication pathways required by the workload, quantum phenomena required by the workload, and a temperature restriction of the workload.

Example 7 is the method of example 1, further comprising: determining that execution of the workload has completed; and removing the QVE.

Example 8 is a system comprising: a memory; and a processing device operatively coupled to the memory, the processing device to: receive, at a cluster management service, a request from a client to create a cluster in which a workload is to be deployed; decompose the request to determine a set of workload parameters; monitor resource availability information of each of a set of quantum machines using a quantum cluster management service (qCMS) executing on each of the set of quantum machines; continuously provide real-time snapshots of the resource availability information of each of the set of quantum machines to a cluster management service (CMS), wherein each of the set of qCMSs federate the CMS across the set of quantum machines; compare the workload parameters to the resource availability information for each of the set of quantum machines to determine whether the workload can be executed on a single quantum machine of the set of quantum machines; and deploy the workload on one or more of the set of quantum machines based on the comparison.

Example 9 is the system of example 8, wherein to monitor the resource availability information of each of the set of quantum machines, each of the set of qCMSs is to: utilize standard hardware application program interfaces (APIs) of the CMS to extract the resource availability information of each of the set of quantum machines.

Example 10 is the system of example 8, wherein to deploy the workload on the one or more quantum machines, the processing device is to: determine that the workload can be executed on a single quantum machine of the set of quantum machines; send a request to a quantum virtual environment (QVE) controller of the single quantum machine to generate a QVE based on the set of workload parameters; and deploy the workload using the QVE.

Example 11 is the system of example 10, wherein to deploy the workload using the QVE, the processing device is to: transmit a quantum assembly language (QASM) file corresponding to the request across a quantum channel to the QVE controller; and execute, by the QVE controller, the workload on the QVE using the QASM file corresponding to the request.

Example 12 is the system of example 10, wherein to deploy the workload using the QVE, the processing device is to: transmit the QVE as a reference to the client.

Example 13 is the system of example 8, wherein to deploy the workload on the one or more quantum machines, the processing device is to: determine that the workload must be executed on two or more quantum machines of the set of quantum machines; entangle one or more qubits from each of the two or more quantum machines to generate a QVE; and deploy the workload using the QVE.

Example 14 is the system of example 10, wherein the QVE comprises a quantum isolation zone.

Example 15 is a non-transitory computer-readable medium having instructions stored thereon which, when executed by a processing device, cause the processing device to: receive, at a cluster management service, a request from a client to create a cluster in which a workload is to be deployed; decompose the request to determine a set of workload parameters; determine resource availability information for each of a set of quantum machines using a set of quantum cluster management services (qCMSs), each of the set of quantum cluster management services executing on a respective quantum machine; compare, by the processing device, the workload parameters to the resource availability information for each of the set of quantum machines to determine whether the workload can be executed on a single quantum machine of the set of quantum machines; and deploy the workload on one or more of the set of quantum machines based on the comparison.

Example 16 is the non-transitory computer-readable medium of example 15, wherein to deploy the workload on the one or more quantum machines, the processing device is to: determine that the workload can be executed on a single quantum machine of the set of quantum machines; send a request to a quantum virtual environment (QVE) controller of the single quantum machine to generate a QVE based on the set of workload parameters; and deploy the workload using the QVE.

Example 17 is the non-transitory computer-readable medium of example 16, wherein to deploy the workload using the QVE, the processing device is to: transmit a quantum assembly language (QASM) file corresponding to the request across a quantum channel to the QVE controller; and execute, by the QVE controller, the workload on the QVE using the QASM file corresponding to the request.

Example 18 is the non-transitory computer-readable medium of example 16, wherein to deploy the workload using the QVE, the processing device is to: transmit the QVE as a reference to the client.

Example 19 is the non-transitory computer-readable medium of example 15, wherein to deploy the workload on the one or more quantum machines, the processing device is to: determine that the workload must be executed on two or more quantum machines of the set of quantum machines; entangle one or more qubits from each of the two or more quantum machines to generate a QVE; and deploy the workload using the QVE.

Example 20 is the non-transitory computer-readable medium of example 15, wherein the workload parameters comprise: a number of qubits required for the workload, one or more communication pathways required by the workload, quantum phenomena required by the workload, and a temperature restriction of the workload.

Example 21 is the non-transitory computer-readable medium of example 15, wherein the processing device is further to: determine that execution of the workload has completed; and remove the QVE.

Example 22 is a system comprising: a memory; and a processing device operatively coupled to the memory, the processing device to: receive, at a cluster management service, a request from a client to create a cluster in which a workload is to be deployed; decompose the request to determine a set of workload parameters; determine resource availability information for each of a set of quantum machines using a set of quantum cluster management services (qCMSs), each of the set of quantum cluster management services executing on a respective quantum machine; compare the workload parameters to the resource availability information for each of the set of quantum machines to determine whether the workload can be executed on a single quantum machine of the set of quantum machines; and deploy the workload on one or more of the set of quantum machines based on the comparison.

Example 23 is the system of example 22, wherein to deploy the workload on the one or more quantum machines, the processing device is to: determine that the workload can be executed on a single quantum machine of the set of quantum machines; send a request to a quantum virtual environment (QVE) controller of the single quantum machine to generate a QVE based on the set of workload parameters; and deploy the workload using the QVE.

Example 24 is the system of example 23, wherein to deploy the workload using the QVE, the processing device is to: transmit a quantum assembly language (QASM) file corresponding to the request across a quantum channel to the QVE controller; and execute, by the QVE controller, the workload on the QVE using the QASM file corresponding to the request.

Example 25 is the system of example 23, wherein to deploy the workload using the QVE, the processing device is to: transmit the QVE as a reference to the client.

Example 26 is the system of example 22, wherein to deploy the workload on the one or more quantum machines, the processing device is to: determine that the workload must be executed on two or more quantum machines of the set of quantum machines; entangle one or more qubits from each of the two or more quantum machines to generate a QVE; and deploy the workload using the QVE.

Example 27 is the system of example 22, wherein the workload parameters comprise: a number of qubits required for the workload, one or more communication pathways required by the workload, quantum phenomena required by the workload, and a temperature restriction of the workload.

Example 28 is the system of example 22, wherein the processing device is further to: determine that execution of the workload has completed; and remove the QVE.

Example 29 is a method comprising: receiving, at a cluster management service, a request from a client to create a cluster in which a workload is to be deployed; decomposing the request to determine a set of workload parameters; monitoring resource availability information of each of a set of quantum machines using a quantum cluster management service (qCMS) executing on each of the set of quantum machines; continuously providing real-time snapshots of the resource availability information of each of the set of quantum machines to a cluster management service (CMS), wherein each of the set of qCMSs federate the CMS across the set of quantum machines; comparing, by a processing device, the workload parameters to the resource availability information for each of the set of quantum machines to determine whether the workload can be executed on a single quantum machine of the set of quantum machines; and deploying the workload on one or more of the set of quantum machines based on the comparing.

Example 30 is the method of example 29, wherein monitoring the resource availability information of each of the set of quantum machines comprises: utilizing standard hardware application program interfaces (APIs) of the CMS to extract the resource availability information of each of the set of quantum machines.

Example 31 is the method of example 29, wherein to deploy the workload on the one or more quantum machines, the processing device is to: determine that the workload can be executed on a single quantum machine of the set of quantum machines; send a request to a quantum virtual environment (QVE) controller of the single quantum machine to generate a QVE based on the set of workload parameters; and deploy the workload using the QVE.

Example 32 is the method of example 31, wherein to deploy the workload using the QVE, the processing device is to: transmit a quantum assembly language (QASM) file corresponding to the request across a quantum channel to the QVE controller; and execute, by the QVE controller, the workload on the QVE using the QASM file corresponding to the request.

Example 33 is the method of example 31, wherein to deploy the workload using the QVE, the processing device is to: transmit the QVE as a reference to the client.

Example 34 is the method of example 29, wherein to deploy the workload on the one or more quantum machines, the processing device is to: determine that the workload must be executed on two or more quantum machines of the set of quantum machines; entangle one or more qubits from each of the two or more quantum machines to generate a QVE; and deploy the workload using the QVE.

Example 35 is the method of example 31, wherein the QVE comprises a quantum isolation zone.

Example 36 is an apparatus comprising: means for receiving, at a cluster management service, a request from a client to create a cluster in which a workload is to be deployed; means for decomposing the request to determine a set of workload parameters; means for determining resource availability information for each of a set of quantum machines using a set of quantum cluster management services (qCMSs), each of the set of quantum cluster management services executing on a respective quantum machine; means for comparing, by a processing device, the workload parameters to the resource availability information for each of the set of quantum machines to determine whether the workload can be executed on a single quantum machine of the set of quantum machines; and means for deploying the workload on one or more of the set of quantum machines based on the comparing.

Example 37 is the apparatus of example 36, wherein the means for deploying the workload on the one or more quantum machines comprises: means for determining that the workload can be executed on a single quantum machine of the set of quantum machines; means for sending a request to a quantum virtual environment (QVE) controller of the single quantum machine to generate a QVE based on the set of workload parameters; and means for deploying the workload using the QVE.

Example 38 is the apparatus of example 37, wherein the means for deploying the workload using the QVE comprises: means for transmitting a quantum assembly language (QASM) file corresponding to the request across a quantum channel to the QVE controller; and means for executing, by the QVE controller, the workload on the QVE using the QASM file corresponding to the request.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. A method comprising:
receiving, at a cluster management service, a request from a client to create a cluster in which a workload is to be deployed;
decomposing the request to determine a set of workload parameters;
determining resource availability information for each of a set of quantum machines using a set of quantum cluster management services (qCMSs), each of the set of qCMSs executing on a respective quantum machine;
comparing, by a processing device, the workload parameters to the resource availability information for each of the set of quantum machines to determine whether the workload can be executed on a single quantum machine of the set of quantum machines; and
deploying the workload on one or more of the set of quantum machines based on the comparing.

2. The method of claim 1, wherein deploying the workload on the one or more quantum machines comprises:
determining that the workload can be executed on a single quantum machine of the set of quantum machines;
sending a request to a quantum virtual environment (QVE) controller of the single quantum machine to generate a QVE based on the set of workload parameters; and
deploying the workload using the QVE.

3. The method of claim 2, wherein deploying the workload using the QVE comprises:
transmitting a quantum assembly language (QASM) file corresponding to the request across a quantum channel to the QVE controller; and
executing, by the QVE controller, the workload on the QVE using the QASM file corresponding to the request.

4. The method of claim 2, wherein deploying the workload using the QVE comprises:
transmitting the QVE as a reference to the client.

5. The method of claim 1, wherein deploying the workload on the one or more quantum machines comprises:
determining that the workload must be executed on two or more quantum machines of the set of quantum machines;
entangling one or more qubits from each of the two or more quantum machines to generate a QVE; and
deploying the workload using the QVE.

6. The method of claim 1, wherein the workload parameters comprise: a number of qubits required for the workload, one or more communication pathways required by the workload, quantum phenomena required by the workload, and a temperature restriction of the workload.

7. The method of claim 1, further comprising:
determining that execution of the workload has completed; and
removing the QVE.

8. A system comprising:
a memory; and
a processing device operatively coupled to the memory, the processing device to:
receive, at a cluster management service, a request from a client to create a cluster in which a workload is to be deployed;
decompose the request to determine a set of workload parameters;
monitor resource availability information of each of a set of quantum machines using a quantum cluster management service (qCMS) executing on each of the set of quantum machines;
continuously provide real-time snapshots of the resource availability information of each of the set of quantum machines to a cluster management service (CMS), wherein each of the set of qCMSs federate the CMS across the set of quantum machines;
compare the workload parameters to the resource availability information for each of the set of quantum machines to determine whether the workload can be executed on a single quantum machine of the set of quantum machines; and
deploy the workload on one or more of the set of quantum machines based on the comparison.

9. The system of claim 8, wherein to monitor the resource availability information of each of the set of quantum machines, each of the set of qCMSs is to:
utilize standard hardware application program interfaces (APIs) of the CMS to extract the resource availability information of each of the set of quantum machines.

10. The system of claim 8, wherein to deploy the workload on the one or more quantum machines, the processing device is to:
determine that the workload can be executed on a single quantum machine of the set of quantum machines;
send a request to a quantum virtual environment (QVE) controller of the single quantum machine to generate a QVE based on the set of workload parameters; and
deploy the workload using the QVE.

11. The system of claim 10, wherein to deploy the workload using the QVE, the processing device is to:
transmit a quantum assembly language (QASM) file corresponding to the request across a quantum channel to the QVE controller; and
execute, by the QVE controller, the workload on the QVE using the QASM file corresponding to the request.

12. The system of claim 10, wherein to deploy the workload using the QVE, the processing device is to:
transmit the QVE as a reference to the client.

13. The system of claim 8, wherein to deploy the workload on the one or more quantum machines, the processing device is to:
determine that the workload must be executed on two or more quantum machines of the set of quantum machines;
entangle one or more qubits from each of the two or more quantum machines to generate a QVE; and
deploy the workload using the QVE.

14. The system of claim 10, wherein the QVE comprises a quantum isolation zone.

15. A non-transitory computer-readable medium having instructions stored thereon which, when executed by a processing device, cause the processing device to:
receive, at a cluster management service, a request from a client to create a cluster in which a workload is to be deployed;
decompose the request to determine a set of workload parameters;
determine resource availability information for each of a set of quantum machines using a set of quantum cluster management services (qCMSs), each of the set of qCMS executing on a respective quantum machine;
compare, by the processing device, the workload parameters to the resource availability information for each of the set of quantum machines to determine whether the workload can be executed on a single quantum machine of the set of quantum machines; and
deploy the workload on one or more of the set of quantum machines based on the comparison.

16. The non-transitory computer-readable medium of claim 15, wherein to deploy the workload on the one or more quantum machines, the processing device is to:
determine that the workload can be executed on a single quantum machine of the set of quantum machines;
send a request to a quantum virtual environment (QVE) controller of the single quantum machine to generate a QVE based on the set of workload parameters; and
deploy the workload using the QVE.

17. The non-transitory computer-readable medium of claim 16, wherein to deploy the workload using the QVE, the processing device is to:
transmit a quantum assembly language (QASM) file corresponding to the request across a quantum channel to the QVE controller; and
execute, by the QVE controller, the workload on the QVE using the QASM file corresponding to the request.

18. The non-transitory computer-readable medium of claim 16, wherein to deploy the workload using the QVE, the processing device is to:
transmit the QVE as a reference to the client.

19. The non-transitory computer-readable medium of claim 15, wherein to deploy the workload on the one or more quantum machines, the processing device is to:
determine that the workload must be executed on two or more quantum machines of the set of quantum machines;
entangle one or more qubits from each of the two or more quantum machines to generate a QVE; and
deploy the workload using the QVE.

20. The non-transitory computer-readable medium of claim 15, wherein the workload parameters comprise: a number of qubits required for the workload, one or more communication pathways required by the workload, quantum phenomena required by the workload, and a temperature restriction of the workload.
